(19) United States
(12) Patent Application Publication
(10) Pub. No.: US 2004/0173607 A1
(43) Pub. Date: Sep. 9, 2004

(54) Article containing microwave susceptor material

(76) Inventors: Nicole L. Blankenbeckler, Richmond, VA (US); Cheng-Hang Chi, Midlothian, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/749,671

(22) Filed: Dec. 31, 2003

Related U.S. Application Data
(60) Provisional application No. 60/438,052, filed on Jan. 3, 2003.

(51) Int. Cl. H05B 6/80

(52) U.S. Cl. 219/730

(57) ABSTRACT

A microwave susceptor material packaging article or ovenware contains susceptor material which differs in an effectiveness to convert microwave energy to heat.

### FIELD OF INVENTION

The present invention is directed to a microwave susceptor material containing packaging article or ovenware useful for uniform heating of a food such as pizza or lasagna by microwave energy wherein a portion of the microwave energy is converted to heat by use of a susceptor material.

### BACKGROUND OF THE INVENTION

The use of microwave energy to heat foods is conventional particularly in kitchens of the western world. However, several major disadvantages are present compared to heating foods using a heat source such as electricity or gas. Two major problems are present through the use of microwave energy, namely, lack of browning on the surface of some foods and lack of uniform heating.

U.S. Pat. No. 2,830,162 discloses heating of a food by application of electromagnetic wave energy to a control element having contact with a food.

U.S. Pat. No. 4,267,420 discloses control of microwave conductivity by use of a coated plastic film which converts some of the microwave energy into heat to allow a browning and/or crisping of the food.

U.S. Pat. No. 4,641,005 discloses a food receptacle employing a thin layer of an electrically conductive material whereby heating of the conductive material browns the exterior of a food.

U.S. Pat. No. 4,892,782 discloses a fibrous microwave susceptor packaging material wrapped around a food item to enhance browning and/or crisping.

U.S. Pat. No. 5,231,268 discloses browning or crisping food by microwave energy using a thermal barrier layer and a susceptor-ink layer pattern printed in varying thickness corresponding to a location where a food is to be packaged.

U.S. Pat. No. 5,349,168 discloses microwaveable packaging compositions with susceptor particles in combination with particles of a blocking agent. A susceptor/blocking agent/matrix may be applied in patterns to allow a variety of temperature profiles in a single sheet. The patterns may have varying susceptor to blocking agent ratios or may have coating compositions of various thicknesses or both.

U.S. Pat. No. 5,175,031 discloses laminated sheets for microwave heating. Included in the disclosure are FIGS. 3, 4 and 6 which show lines of demarcation between areas of susceptor material.

U.S. Pat. No. 6,137,099 discloses a package for microwave cooking with a corrugated sheet of susceptor material adapted to be at least partially wrapped around a food product.

Handbook of Microwave Technology For Food Applications published 2001, edited by Datta and Anantheswara, on pages 425 to 428 discloses microwave performance in heating foods including a “shadow” effect that a food product casts under itself. Such shadow prevents significant amounts of energy being reflected to heat the center bottom of the food product.

A need exists for a new food package for heating food with microwave energy whereby uniform heating of the food occurs both at the edges of the food and also within the interior.

### SUMMARY OF THE INVENTION

The present invention is directed to a susceptor material containing packaging article or ovenware comprising a substrate supporting a susceptor material for converting microwave energy to heat wherein:

(i) a central portion of the susceptor material surface is centered on a surface of the substrate and

(ii) on the basis of an equal amount of striking microwave energy an area encompassing the central portion of the susceptor material converts more microwave energy to heat in comparison to an equal area adjacent edges of the susceptor material wherein a gradient of susceptor material effectiveness is present in at least a portion of a line which extends from a central area of the susceptor material or from a midpoint of susceptor material to a terminal edge.

It is understood that (a) the use of “an equal amount of striking microwave energy” is for comparison purposes only and (b) the comparative areas do not overlap.

Also, the invention is directed to a packaging article containing a food, a method of forming the packaging article containing a food and a method of heating a food employing the susceptor material.

### DETAILED DESCRIPTION OF THE INVENTION

An overall purpose of the present invention is to allow uniform heating of a food product in a uniform manner using microwave energy. Although microwave heating for a single serving portion can produce satisfactory results, the use of microwave heating typically results in non-uniform heating as the size of the food increases. The present invention provides a solution to such non-uniformity in heating larger food products particularly food products which cannot be stirred following heating.

With heating a large food product through microwave energy, a phenomenon is considered to exist which can be described as a “shadow effect”. Without being bound to any theory, a shadow effect may be compared to a shadow being cast from a light source striking an object. In the case of heating of a food by microwave energy, it is believed that absorption of microwave energy takes place due to propagating waves as the waves repeatedly impact a bottom surface of the food product. Nonabsorbent microwave portions reflect from a floor of a microwave oven to the food product with each successive reflection toward a center portion of the food product resulting in less energy. An innermost central portion of the food is considered to be in a shadow with a line of demarcation between shadow and non-shadow areas.

In the event the mass or volume of the food is not significant, any shadow effect, if present, does not greatly influence uniform heating of the food. However, as the food product mass increases, non-uniform heating takes place. A common example results in the edges of the food being overcooked while a center portion is undercooked.

In the present invention the solution to obtain a degree of uniform heating of a solid food product is to employ a susceptor material in a manner which serves to minimize and overcome non-uniform heating. Although with a shadow effect a line of demarcation is present between shadow and non-shadow areas, the present invention utilizes a difference in susceptor material effectiveness extending from a central portion of the surface material surface area to the edges of the area. As employed herein “susceptor material effectiveness” means the ability of the susceptor material to convert striking microwave energy to heat. Therefore, a difference in susceptor material effectiveness is determined on a basis of an equal amount of striking microwave energy and an equal susceptor surface area. However it is understood that as a practical manner striking microwave energy will vary.

Consistent with the above theory of a shadow effect, in one embodiment of the invention the susceptor material effectiveness may be uniform within a central area of the susceptor material. Thereafter, a change with decreasing susceptor material effectiveness is present extending to a terminal edge of the susceptor material wherein no sharp line of demarcation is present. Terminal edge means the outer circumference of the susceptor material. In another embodiment of the invention a change of susceptor material effectiveness decreases from a midpoint of the susceptor material surface to a terminal edge of the susceptor material. Typically, the surface of the susceptor material will have a geometric configuration such as a circle or rectangle. Therefore, a midpoint will be present on the surface of such configuration. It is understood that the change or gradient in material surface effectiveness may be uniform from a central area or midpoint towards edges of the susceptor material or may be non-uniform. However, it is understood that the term “gradient” does not included a change in step-wise fashion, i.e. an area of uniform susceptor material effectiveness followed by another area of uniform but lessor material effectiveness.

The term “susceptor material” is employed in its normal definition in the microwave art, namely, a material which absorbs energy from microwaves and converts the energy in the form of heat.

Susceptor materials are well-known and include metals such as aluminum, antimony, bronze, chromium, copper, gold, iron, nickel, tin and zinc. Often the metals are present in powder or flake form with a binder or intermingled in a polymer film. Other conductive materials are also employed as susceptor materials such as metal oxides and carbon in the form of graphite or carbon black. These susceptive materials may be used alone or in combination with each other.

A difference in susceptor material effectiveness can be obtained with varying techniques in application of the susceptor material onto a substrate. One technique is to employ varying thicknesses of the same susceptor material. Other techniques include varying the amount of susceptor material, employing different susceptor materials and employing two or more susceptor materials in conjunction with one another but at differing ratios. A further technique is to use varying amounts of a blocking agent which interferes with the susceptor to convert microwave energy to heat.

In the present food package the susceptor materials typically will be present on a substrate which allows passage of microwave energy. Typical dielectric materials employed as supports for susceptor material are likewise suitable. The support will have thermal stability at temperatures encountered in a microwave oven. Although a cellulosic material is suitable under some circumstances, generally it is less desirable than other materials. Examples of other materials include fiberglass, polyester, aramids, fluoropolymers, polyimides and phenolics. A preferred example of a high temperature support is an aramid such as sold under the trademark Kevlar® aramid. In preferred embodiments of the invention the susceptor material covers an entire substrate surface or covers an entire substrate surface except for areas adjacent edges of the substrate.

Also, for a complete food package a food product, particularly while being cooked in a microwave oven, will be positioned in contact with or in close proximity to the susceptor material. Typically the susceptor material will be below the food product. Thereafter, an outer covering surrounds the food on a surface which does not face the susceptor material. Such outer coverings are well-known and include coverings which are removed prior to heating using microwave energy or coverings which stay in place (with venting) during microwave heating. An example of a covering is polyester such as polyethylene terephthalate. The food products may require refrigeration or may be frozen prior to being cooked as is well-known.

In contrast to the food packaging items mentioned above, which are typically single use materials tailored for specific food item(s), ovenware is often designed to be used over a period of time with varying multiple food items. This means that unless designed for a food of specific size and shape (for example, round pizza of a certain diameter and thickness), a single piece of ovenware may not be optimum for widely varying food sizes and/or shapes. Nevertheless, ovenware can be designed for specific shapes and sizes or may be designed to accommodate a range of shapes and/or sizes. Such ovenware may be molded by conventional techniques from heat resistant thermoset or thermoplastic polymers, for example, liquid crystalline polymers having a relatively high melting point. Typically the thermoplastic polymer or a thermoset polymer is mixed with a susceptor material before being molded and crosslinked. In a single molding it may be difficult to vary the concentration of the susceptor within that part. However, the thickness of the part may easily be changed, so there may be a change in the thickness of the susceptor containing material. Alternatively, susceptor containing parts of a single thickness or different thicknesses and/or of varying susceptor concentration may be plied up within the ovenware or as part of the ovenware to form areas (with varying thicknesses) of susceptor containing layers. One or more of these layers may be tapered so that the change in ability to absorb microwave radiation will gradually vary across the surface of the susceptor containing material. Using the plied up method, it is possible to tailor somewhat the variation in the food size or shape useful with that piece of ovenware. Another way of tailoring ovenware for specific ranges of food shapes and/or sizes is to have ovenware of various sizes and/or shapes for particular size and/or shape ranges.

In the following examples, all parts and percentages are by weight unless otherwise indicated.

### EXAMPLE 1

A. Susceptor Preparation:

A microwave gradient susceptor was prepared. The substrate used was a sheet of 30 cm length by 30 cm width, 0.1 mm thickness aramid paper (Type 4N710 from DuPont). A uniform base coat of 0.127 mm (5 mils) wet film thickness was first applied to the substrate using a wet film applicator available from Paul N. Gardner Company. The composition of the base coat was 14.7% modified soy protein (Pro-cote 200 from Bunge), 1.1% glycerin, 0.74% ammonia, and 83.46% water. The coated sheet was dried in a 100 degree C. oven for 15 minutes. A second coating of microwave interactive ink was applied to create a half-circle ink deposition of 15.2 cm diameter with a gradual increase of coated ink towards the center of the circle. The composition of the microwave interactive ink by weight was 11.0% carbon black (Black Pearl 4350 from Cabot), 10.1% soy protein (Pro-cote 2500 from Bunge), 4.4% surfactant (Tween 80 from Uniquema), 1.0% ammonia, 1.0% glycerin, 0.2% biocide (Proxel GXL), 0.05% defoamer (Sag 770 from GE Silicones) and 72.25% water. The applicator used was a 7.6 cm wide wet film applicator with a gap of 0.051 mm or 2 mils (Model AP-SS324 from Paul N. Gardner Company). Two shims were placed at one end (End A) of the applicator to increase the gap to 0.145 mm (5.7 mils). This created a wet film gap with a gradient from 0.145 mm at (End A) to 0.051 mm at the other end (End B). The half-circle ink coating was created by holding End A of the applicator stationary while rotating End B by 1800. The coated sheet was dried in a 100 degree C. oven for 20 minutes and then allowed to cool.

B. Microwave Cooking Test:

The half circle of coated susceptor was cut out, perforated with pinholes and placed on an inverted porous paper plate in a 900 W microwave oven. A frozen pizza (15.2 cm diameter Tombstone Pizza for One with Extra Cheese) was placed on the perforated half circle with the ink side in contact with the pizza and allowed to cook for 4 minutes at 100% power. The result showed that the crust was evenly browned on the side with the susceptor and not browned at all on the side without the susceptor.

### COMPARATIVE EXAMPLE 2

### Aluminum Susceptor

The aluminum susceptor that came with the Tombstone Pizza for One was perforated with pinholes and placed on an inverted paper plate (also perforated) in a 900 W microwave oven. A 15.2 cm diameter frozen pizza (Tombstone Pizza for One with Extra Cheese) was placed on the perforated circle with the aluminized side in contact with the pizza and allowed to cook for 4 minutes at 100% power. The crust was browned mainly on the edges after cooking.

What is claimed is:

1. An article suitable for heating a food by microwave energy comprising a substrate supporting a susceptor material for converting microwave energy to heat wherein:
(i) a central portion of the susceptor material is centered on a supporting surface of the substrate and
(ii) on the basis of an equal amount of striking microwave energy an area encompassing the central portion of the susceptor material converts more microwave energy to heat in comparison to an equal area adjacent edges of the susceptor material wherein a gradient of susceptor material effectiveness is present in at least a portion of a line which extends from a central area of the susceptor material or from a midpoint of susceptor material to a terminal edge.

2. The article of claim 1 which is a food support packaging article.

3. The article of claim 1 which is ovenware.

4. The article of claim 1 with a gradient of susceptor material effectiveness extending from the central portion of the susceptor material to edges of the material.

5. The article of claim 4 wherein the gradient comprises a different thickness of susceptor material.

6. The article of claim 4 wherein the gradient comprises a different concentration of susceptor material.

7. The article of claim 4 wherein the gradient comprises a different concentration of a blocking agent.

8. The article of claim 4 wherein the gradient comprises both a different thickness and a different concentration of susceptor material.

9. The article of claim 1 wherein the area of susceptor material comprises a circle.

10. The article of claim 1 wherein the area of susceptor material comprises a rectangle.

11. A method of heating a food product comprising subjecting the food product to microwave energy wherein the food is positioned on a substrate supporting a susceptor material for converting microwave energy to heat wherein:
(i) a central portion of the susceptor material is centered on a supporting surface of the substrate and
(ii) on the basis of an equal amount of striking microwave energy an area encompassing the central portion of the susceptor material converts more microwave energy to heat in comparison to an equal area adjacent edges of the susceptor wherein a gradient of susceptor material effectiveness is present in at least a portion of a line which extends from a central area of the susceptor material or from a midpoint of susceptor material to a terminal edge.

12. The method of claim 1 1 with a gradient of susceptor material effectiveness extending from the central portion of the susceptor material to edges of the material.

13. The method of claim 12 wherein the gradient comprises a different thickness of susceptor material.

14. The method of claim 12 wherein the gradient comprises a different concentration of a blocking agent.

15. The method of claim 12 wherein the gradient comprises a different concentration of susceptor material.

16. The method of claim 12 wherein the gradient comprises both a different thickness and a different concentration of susceptor material.

17. The method of claim 11 wherein the area of susceptor material comprises a circle.

18. The method of claim 11 wherein the area of susceptor material comprises a rectangle.

19. The method of claim 11 wherein the food product is pizza.

20. The method of claim 11 wherein the food product is lasagna.

21. A food packaging article comprising:
(a) a substrate supporting a susceptor material for converting microwave energy to heat wherein:
(i) a central portion of the susceptor material is centered on a supporting surface of the substrate and
(ii) on the basis of an equal amount of striking microwave energy an area encompassing the central portion of the susceptor material converts more microwave energy to heat in comparison to an equal area adjacent edges of the material, wherein a gradient of susceptor material effectiveness is present in at least a portion of a line which extends from a central area of the susceptor material or from a midpoint of susceptor material to a terminal edge,
(b) a food positioned on the susceptor material.
(c) a covering surrounding a surface of the food not positioned on the surface.

22. The food packaging article of claim 21 wherein the food is pizza.

23. The food packaging article of claim 21 wherein the food is lasagna.

24. A method of making a food support packaging article comprising the steps of:
(a) forming a substrate supporting a susceptor material for converting microwave energy to heat wherein:
(i) a central portion of the susceptor material is centered on a supporting surface of the substrate and
(ii) on the basis of an equal amount of striking microwave energy an area encompassing the central portion of the susceptor material converts more microwave energy to heat in comparison to an equal area adjacent edges of the susceptor material wherein a gradient of susceptor material effectiveness is present in at least a portion of a line which extends from a central area of the susceptor material or from a midpoint of the susceptor material to a terminal edge,
(b) positioning a food product on the susceptor material and
(c) applying a wrapping on the food.

25. The method of claim 24 with an added step of freezing the food product.

26. The method of claim 24 wherein the food product is pizza.

27. The method of claim 24 wherein the food product is lasagna.

28. A method of preparing a food packaging article comprising:
(a) preparing a substrate supporting a susceptor material for converting microwave energy to heat wherein:
(i) a central portion of the susceptor material is centered on a supporting surface of the substrate and
(ii) on the basis of an equal amount of striking microwave energy an area encompassing the central portion of the susceptor material surface area converts more microwave energy to heat in comparison to an equal area adjacent edges of the susceptor material wherein a gradient of susceptor material effectiveness is present in a least a portion of a line which extends from a central area of the susceptor material or from a midpoint of susceptor material to a terminal edge,
(b) positioning a food product on the susceptor material and
(c) applying a covering to surround the food product on a surface which does not face the susceptor material.

29. The method of claim 28 wherein the food is pizza.

30. The method of claim 28 wherein the food is lasagna.
